(19) United States
(12) Patent Application Publication
(10) Pub. No.: US 2022/0229443 A1
(43) Pub. Date: Jul. 21, 2022

(54) AUTONOMOUS MOBILE SYSTEM, AUTONOMOUS MOBILE METHOD, AND AUTONOMOUS MOBILE PROGRAM

(71) Applicant: TOYOTA JIDOSHA KABUSHIKI KAISHA, Toyota-shi (JP)

(72) Inventors: Tetsuya TAIRA, Nagakute-shi (JP); Shiro ODA, Anjo-shi (JP); Satoshi TOYOSHIMA, Okazaki-shi (JP); Yuta WATANABE, Toyota-shi (JP); Takeshi MATSUI, Nisshin-shi (JP); Takayoshi NASU, Okazaki-shi (JP); Kei YOSHIKAWA, Nagoya-shi (JP); Yusuke OTA, Nagakute-shi (JP); Yutaro ISHIDA, Toyota-shi (JP); Yuji ONUMA, Nagoya-shi (JP)

(21) Appl. No.: 17/648,237

(22) Filed: Jan. 18, 2022

(30) Foreign Application Priority Data
Jan. 21, 2021 (JP) 2021-007933

(51) Int. Cl. G05D 1/02

(52) U.S. Cl. CPC G05D 1/0282; G05D 2201/0211

(57) ABSTRACT

An autonomous mobile system according to the present embodiment is an autonomous mobile system that autonomously moves in a facility using position information. In a case where the position information is lost due to an activation of a forced stop switch for stopping autonomous movement of the autonomous mobile system, when the activation of the forced stop switch is released and the autonomous movement is restored, the autonomous mobile system acquires the position information from a facility camera in the facility that has captured an image of the autonomous mobile system or from another autonomous mobile system that has detected the autonomous mobile system.

### CROSS-REFERENCE TO RELATED APPLICATION

This application claims priority to Japanese Patent Application No. 2021-007933 filed on Jan. 21, 2021, incorporated herein by reference in its entirety.

### BACKGROUND

### 1. Technical Field

The present disclosure relates to an autonomous mobile system, an autonomous mobile method, and an autonomous mobile program.

### 2. Description of Related Art

Development of autonomous mobile devices that autonomously move within a predetermined building or facility is in progress. Such an autonomous mobile device having a loading platform can serve as an autonomous transportation device that automatically delivers a package. The autonomous transportation device can, for example, deliver the package loaded at the departure point to the destination by autonomously moving from the departure point to the destination.

For example, Japanese Unexamined Patent Application Publication No. 2007-249735 (JP 2007-249735 A) and the like describes that, when an autonomous mobile robot that autonomously travels in a predetermined area is brought to in an error state and loses its own position and direction, a radio frequency identification (RFID) tag installed in the traveling area is read by a reader or a landmark is imaged with a camera mounted on the robot to restore the grasp of its own position.

### SUMMARY

In order to travel an autonomous mobile robot such as the one described in JP 2007-249735 A and the like, targets such as RFID tags and landmarks need to be installed in advance in the facility in case the robot is brought to an error state and loses its position information. Therefore, there is a possibility that an autonomous mobile robot such as the one described in JP 2007-249735 A and the like cannot be restored when an error occurs at a position where the RFID tag and the like cannot be recognized and the position information is lost.

The present disclosure has been made to solve such an issue, and provides an autonomous mobile system, an autonomous mobile method, and an autonomous mobile program capable of restoring easily even when the position information is lost.

An autonomous mobile system according to the present embodiment is an autonomous mobile system that autonomously moves in a facility using position information. In a case where the position information is lost due to an activation of a forced stop switch for stopping autonomous movement of the autonomous mobile system, when the activation of the forced stop switch is released and the autonomous movement is restored, the autonomous mobile system acquires the position information from a facility camera in the facility that has captured an image of the autonomous mobile system or from another autonomous mobile system that has detected the autonomous mobile system. With such a configuration, the autonomous mobile system can be easily restored even when losing the position information.

In the above autonomous mobile system, when the forced stop switch is activated, transmission of a heartbeat signal that is periodically transmitted to a server device communicably connected to the autonomous mobile system may be stopped, and when the activation of the forced stop switch is released and the autonomous movement is restored, the autonomous mobile system may resume the transmission of the heartbeat signal to acquire the position information via the server device. With such a configuration, the server device can easily detect the activation of the forced stop switch.

In the above autonomous mobile system, the autonomous mobile system may acquire direction information indicating a direction of the autonomous mobile system together with the position information. With such a configuration, the autonomous mobile system can be easily restored even when losing the position information.

In the above autonomous mobile system, when the forced stop switch is activated, the autonomous mobile system may notify an administrator of the autonomous mobile system of the activation of the forced stop switch. With such a configuration, the administrator can easily detect the forced stop.

In the above autonomous mobile system, the autonomous mobile system that has acquired the position information may move to a base point fixed in the facility, and may acquire base point information that serves as a reference for the position information by positioning at the base point. With such a configuration, the accuracy of the position information can be improved.

An autonomous mobile system according to the present embodiment includes: an autonomous mobile device that autonomously moves in a facility using position information; a facility camera that is fixed in the facility and captures an image of a periphery of the facility camera to generate image data; and a server device that transmits and receives traveling information to and from the autonomous mobile device, and acquires the image data from the facility camera. In a case where the autonomous mobile device has lost the position information due to an activation of a forced stop switch for stopping autonomous movement of the autonomous mobile device, when the activation of the forced stop switch is released and the autonomous movement is restored, the server device acquires the position information of the autonomous mobile device from the facility camera that has captured an image of the autonomous mobile device or from another autonomous mobile device that has detected the autonomous mobile device, and transmits the acquired position information to the autonomous mobile device. The autonomous mobile device acquires the position information from the server device. With such a configuration, the autonomous mobile device can be easily restored even when losing the position information.

In the above autonomous mobile system, the autonomous mobile device may stop transmission of a heartbeat signal that is periodically transmitted to the server device, when the forced stop switch is activated, and may resume the transmission of the heartbeat signal to acquire the position information via the server device, when the activation of the forced stop switch is released and the autonomous movement is restored. With such a configuration, the server device can easily detect the activation of the forced stop switch.

In the above autonomous mobile system, the autonomous mobile device may acquire direction information indicating a direction of the autonomous mobile device together with the position information. With such a configuration, the autonomous mobile device can be easily restored even when losing the position information.

In the above autonomous mobile system, the autonomous mobile device or the server device may notify an administrator of the autonomous mobile system of the activation of the forced stop switch, when the forced stop switch is activated. With such a configuration, the administrator can easily detect the forced stop.

In the above autonomous mobile system, the autonomous mobile device that has acquired the position information may move to a base point fixed in the facility, and may acquire base point information that serves as a reference for the position information by positioning at the base point. With such a configuration, the accuracy of the position information can be improved.

An autonomous mobile method according to the present embodiment is an autonomous mobile method for an autonomous mobile device that autonomously moves in a facility using position information. The autonomous mobile method includes causing the autonomous mobile device to acquire the position information from a facility camera in the facility that has captured an image of the autonomous mobile device or from another autonomous mobile device that has detected the autonomous mobile device, in a case where the autonomous mobile device has lost the position information due to an activation of a forced stop switch for stopping autonomous movement of the autonomous mobile device, and when the activation of the forced stop switch is released and the autonomous movement is restored. With such a configuration, the autonomous mobile device can be easily restored even when losing the position information.

An autonomous mobile program according to the present embodiment is an autonomous mobile program for an autonomous mobile device that autonomously moves in a facility using position information. The autonomous mobile program causes a computer to execute acquisition of the position information by the autonomous mobile device from a facility camera in the facility that has captured an image of the autonomous mobile device or from another autonomous mobile device that has detected the autonomous mobile device, in a case where the autonomous mobile device has lost the position information due to an activation of a forced stop switch for stopping autonomous movement of the autonomous mobile device, and when the activation of the forced stop switch is released and the autonomous movement is restored. With such a configuration, the autonomous mobile device can be easily restored even when losing the position information.

The present embodiment can provide an autonomous mobile system, an autonomous mobile method, and an autonomous mobile program capable of restoring easily even when the position information is lost.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view illustrating a mobile robot according to a first embodiment;

FIG. 2 is a perspective view illustrating the mobile robot according to the first embodiment;

FIG. 3 is a block diagram illustrating the mobile robot according to the first embodiment;

FIG. 4 is a flowchart illustrating an operation of acquiring position information when the mobile robot according to the first embodiment loses the position information due to the activation of a forced stop switch for stopping autonomous movement;

FIG. 5 is a block diagram illustrating a server device according to a second embodiment; and

FIG. 6 is a sequence diagram illustrating the operation of an autonomous mobile system according to the second embodiment.

### DETAILED DESCRIPTION OF EMBODIMENTS

Hereinafter, the present disclosure will be described through embodiments of the disclosure, but the disclosures in the claims are not limited to the following embodiments. Moreover, not all of the configurations described in the embodiments are indispensable as means for solving the problem. For the sake of clarity, the following description and drawings have been omitted and simplified as appropriate. In each drawing, the same elements are designated by the same reference signs, and duplicate descriptions are omitted as necessary.

### First Embodiment

An autonomous mobile system according to a first embodiment will be described. In the present embodiment, the autonomous mobile system may be replaced with an autonomous mobile device, or the autonomous mobile device may be replaced with the autonomous mobile system. Further, the autonomous mobile system according to the present embodiment may include the autonomous mobile device. The autonomous mobile device autonomously moves in a predetermined facility. The autonomous mobile device may be, for example, a mobile robot that autonomously moves, or a transportation robot that autonomously moves to transport an object. Hereinafter, the mobile robot will be described as an example of the autonomous mobile device. The mobile robot will be described separately in “Structure of Mobile Robot” and “Operation of Mobile Robot”.

Structure of Mobile Robot

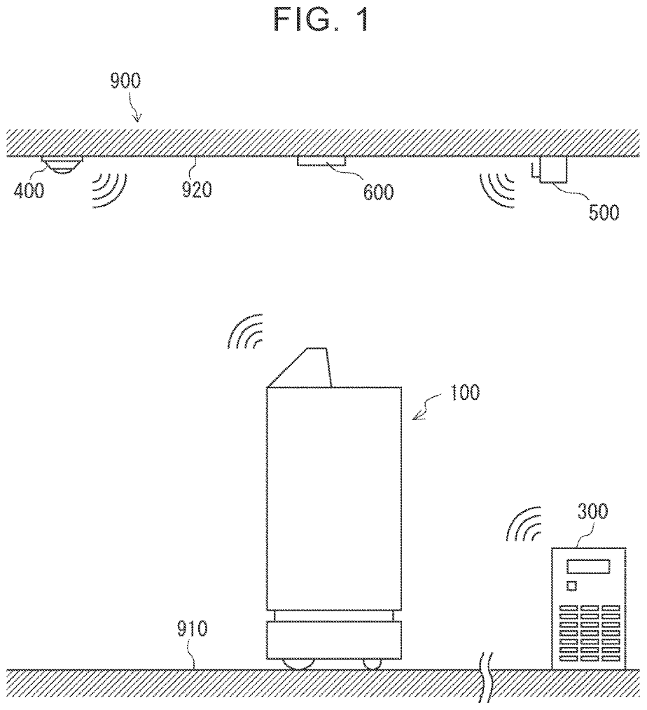

FIG. 1 is a schematic view illustrating the mobile robot according to the first embodiment. As shown in FIG. 1, a mobile robot 100 is an example of the autonomous mobile device that autonomously moves in a predetermined facility 900. The predetermined facility 900 is, for example, a hospital. The predetermined facility 900 is not limited to a hospital, and may be a hotel, a shopping mall, or the like as long as the mobile robot 100 can move autonomously in the predetermined facility 900.

The mobile robot 100 autonomously moves on a floor surface 910 in the facility 900 using position information in the facility 900. The position information includes, for example, the current position of the mobile robot 100. The position information may include, for example, the direction of the mobile robot 100, the position of an obstacle around the mobile robot 100, and the like.

A facility camera 400 is fixed in the facility 900. For example, the facility camera 400 is fixed to a ceiling 920 of the facility 900, and captures images of the periphery of the facility camera 400 to generate image data. The facility camera 400 captures images of, for example, an aisle, a corner, a passerby, the mobile robot 100, and the like. A plurality of the facility cameras 400 may be provided in the facility 900.

The mobile robot 100 and the facility camera 400 may be connected to each other so as to be able to communicate with each other via information transmission means such as wireless communication. The mobile robot 100 and the facility camera 400 may be connected to each other so as to be able to directly communicate with each other, or may be connected to each other so as to be able to communicate with each other via an access point 500 and a server device 300. Therefore, the mobile robot 100 may acquire the image data directly from the facility camera 400, or may acquire the image data via the access point 500 and the server device 300.

The access point 500 is, for example, a wireless local area network (LAN) access point. The access point 500 is fixed in the facility 900 and acquires position information, traveling information, and the like from the mobile robot 100 located in the periphery of the access point 500. A plurality of the access points 500 may be provided in the facility 900.

A plurality of the mobile robots 100 may autonomously move in the facility 900. When the mobile robots 100 autonomously move, the mobile robots 100 may be connected to each other so as to be able to communicate with each other via information transmission means such as wireless communication. The mobile robots 100 may be connected to each other so as to be able to directly communicate with each other, or may be connected to each other so as to be able to communicate with each other via the access point 500 and the server device 300. Here, when distinguishing another mobile robot from a specific mobile robot 100, the other mobile robot is referred to as another mobile robot 100A or simply a mobile robot 100A to distinguish the other mobile robot from the mobile robot 100.

A base point 600 may be fixed in the facility 900. The base point 600 is, for example, a mark provided on the ceiling 920. The base point 600 is not limited to the mark provided on the ceiling 920. The base point 600 may be fixed to the floor surface 910, the wall surface, or the like, instead of the ceiling 920. Further, the base point 600 is not limited to the mark. The base point 600 may be a code such as a QR code (registered trademark) or a bar code, a light emitting point, a radio frequency identification (RFID) tag, a battery charger built in the mobile robot 100, or the like. A plurality of the base points 600 may be provided in the facility 900.

By positioning at the base point 600 fixed in the facility 900, the mobile robot 100 acquires base point information that serves as a reference for the position in the facility 900. For example, the base point information is acquired by stopping at a position where the base point information can be acquired, such as directly below or directly above the base point 600. The base point information acquired from the base point 600 serves as a reference for the position information in the facility 900, and is information for improving the accuracy of the position information. For example, the mobile robot 100 calculates the position information by adding distance information detected by a sensor group of the mobile robot 100 to the base point information acquired from the base point 600. Specifically, the mobile robot 100 updates the position information by adding the mileage and the traveling direction from the base point 600. As a result, the mobile robot 100 can improve the accuracy of the position information.

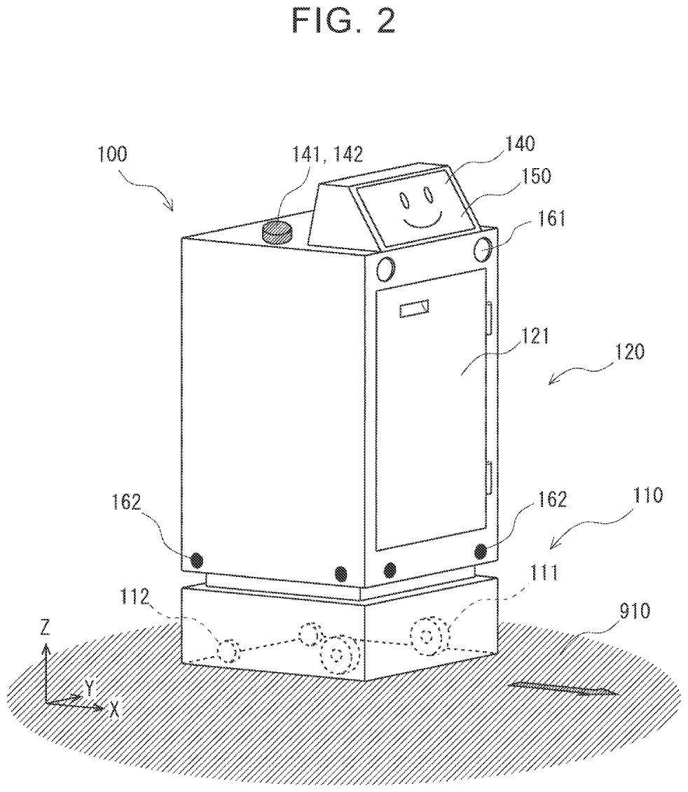

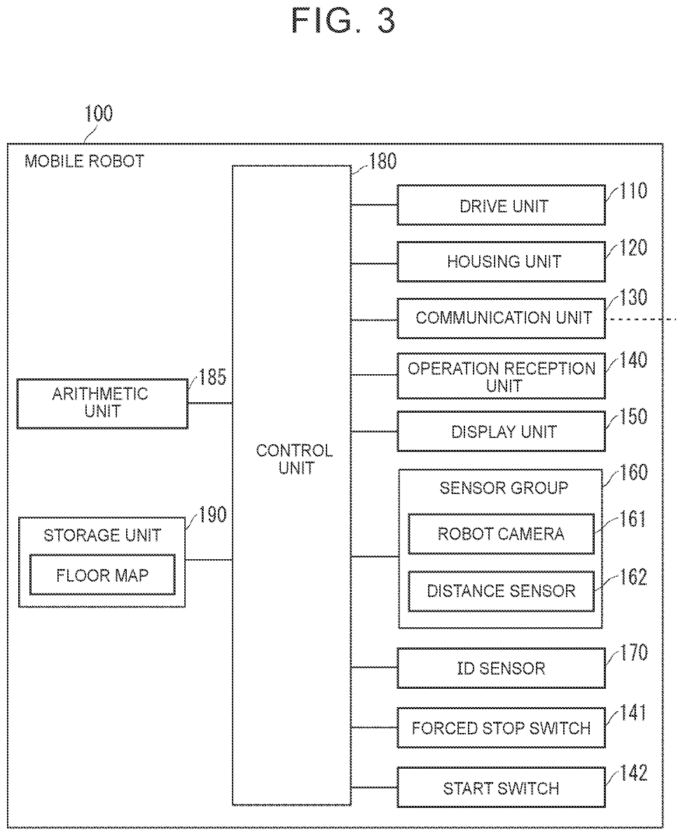

FIG. 2 is a perspective view illustrating the mobile robot 100 according to the first embodiment. FIG. 3 is a block diagram illustrating the mobile robot 100 according to the first embodiment. As shown in FIGS. 2 and 3, the mobile robot 100 includes a drive unit 110, a housing unit 120, a communication unit 130, an operation reception unit 140, a display unit 150, a sensor group 160, a forced stop switch 141, a start switch 142, an identification (ID) sensor 170, a control unit 180, an arithmetic unit 185, and a storage unit 190.

As shown in FIG. 2, the mobile robot 100 is a mobile body that moves on the floor surface 910 that is a moving surface. Here, for convenience of explanation of the mobile robot 100, the XYZ orthogonal coordinate axis system is used. The floor surface 910 is the XY-plane, and the upper side is the +Z axis direction.

The drive unit 110 functions as means for moving the mobile robot 100. The drive unit 110 may include two drive wheels 111 that are in contact with the floor surface 910 and are rotatable independently from each other about one rotation axis that extends in a direction (right-left direction or Y-axis direction in the drawing) perpendicular to a straight direction (front-rear direction or X-axis direction in the drawing), and casters 112 in contact with the floor surface 910. The mobile robot 100 moves forward or rearward in a manner such that the drive wheels 111 disposed on the right and left sides are driven at the same rotation speed, and makes a turn by generating a difference in the rotation speed or rotation direction between the right and left drive wheels 111. The drive unit 110 drives the drive wheels 111 in accordance with commands from the control unit 180.

The housing unit 120 is disposed above the drive unit 110 of the mobile robot 100. The housing unit 120 may have a storage chamber door 121. When the storage chamber door 121 is opened, a storage chamber for storing a predetermined object is provided inside the housing unit 120. That is, the mobile robot 100 can also be a transportation robot that transports a predetermined object. The housing unit 120 may open and close the storage chamber door 121 in accordance with a command from the control unit 180.

As shown in FIG. 3, the communication unit 130 is an interface that is communicably connected to the outside. The communication unit 130 includes, for example, an antenna and a circuit that modulates or demodulates a signal transmitted through the antenna. The communication unit 130 receives the image data directly from the facility camera 400 or via the access point 500 and the server device 300.

Further, the communication unit 130 may receive information related to the destination, the position information, the traveling information and the like from the server device 300. Further, the communication unit 130 may transmit information related to the state of the mobile robot 100, the position information, the traveling information, and the like to the server device 300. Further, the communication unit 130 may transmit and receive the position information and the image data to and from the other mobile robot 100A directly or via the access point 500 and the server device 300.

The communication unit 130 may periodically transmit a heartbeat signal to the server device 300. The heartbeat signal may include log data indicating the state of the mobile robot 100 in the chronological order. Further, the heartbeat signal may include the ID of the mobile robot 100.

The communication unit 130 connects to the control unit 180, outputs, to the control unit 180, a signal including information transmitted from the facility camera 400 and the server device 300, and transmits, to the server device 300, the signal including the information output from the control unit 180.

The operation reception unit 140 receives an input operation from the user and transmits an operation signal to the control unit 180. As means for receiving an input operation from the user, the operation reception unit 140 may include, for example, an operation button, a touch panel superimposed on the display unit 150, or the like. The user operates the input operation means described above to turn on and off the power supply, open and close the storage chamber door 121, and the like.

The display unit 150 is provided, for example, so as to project from the upper surface of the housing unit 120. The display unit 150 is, for example, a display unit including a rectangular liquid crystal panel. The display unit 150 appropriately displays information in accordance with the command from the control unit 180. A touch panel that receives operations from the user may be superimposed on the display unit 150.

The sensor group 160 includes sensors that acquire data necessary for the mobile robot 100 to move autonomously. The sensor group 160 includes, for example, a robot camera 161 and a distance sensor 162. The sensor group 160 may include sensors other than the robot camera 161 and the distance sensor 162. For example, the sensor group 160 may include an encoder provided in the drive unit 110.

The robot camera 161 is disposed in an upper portion of the housing unit 120 and below the display unit 150, for example. In the robot camera 161, two camera units having the same angle of view may be disposed horizontally separated from each other. With this configuration, the images captured by each camera unit are output to the control unit 180 as the image data. Further, when the base point 600 is a mark provided on the ceiling 920, the robot camera 161 may capture an image of the mark on the ceiling 920.

The distance sensor 162 is disposed, for example, in the lower portion of the housing unit 120. The distance sensor 162 may be disposed in the lower portion of each of a surface on the +X-axis direction side, a surface on the −X-axis direction side, a surface on the +Y-axis direction side, and a surface on the −Y-axis direction side of the housing unit 120. The distance sensor 162 measures the distance between an object around the mobile robot 100 and the mobile robot 100. The control unit 180 recognizes the obstacle around the mobile robot 100 by analyzing the image data output by the robot camera 161 and the detection signals output by the distance sensor 162, and measures the distance between the mobile robot 100 and the obstacle.

The mobile robot 100 may acquire the position information by any of the sensors in the sensor group 160. For example, the mobile robot 100 captures an image of the base point 600 with the robot camera 161 to acquire the base point information, and calculates the position information from the base point information. The mobile robot 100 may acquire the position information from the server device 300, the facility camera 400, and the other mobile robot 100A via the communication unit 130.

The ID sensor 170 is provided, for example, near the display unit 150. The ID sensor 170 identifies the ID of the user who operates the mobile robot 100, and detects a unique identifier included in the ID card owned by each user. The ID sensor 170 includes, for example, an antenna for reading information on a wireless tag. The user brings the ID card close to the ID sensor 170 such that the mobile robot 100 is caused to recognize the ID of the user who is the operator.

The forced stop switch 141 and the start switch 142 may be respectively provided as a forced stop button and a restart button in the vicinity of the operation reception unit 140, or may be superimposed on the touch panel of the display unit 150, for example.

The forced stop switch 141 stops the autonomous movement of the mobile robot 100. That is, the forced stop switch 141 stops the traveling of the mobile robot 100. The forced stop switch 141 may stop other functions of the mobile robot 100. For example, the forced stop switch 141 may stop the function of the drive unit 110 as moving means, or may stop the function of the communication unit 130 as communication means. Further, the forced stop switch 141 may stop the sensor function of the sensor group 160. The forced stop switch 141 may stop at least one function of the functions of the mobile robot 100, or may stop all the functions of the mobile robot 100. When the forced stop switch 141 is activated, the transmission of the heartbeat signal that is periodically transmitted to the server device 300 communicably connected to the mobile robot 100 may be stopped. As a result, the server device 300 can detect that the mobile robot 100 has stopped the autonomous movement.

The start switch 142 releases the activation of the forced stop switch 141 and restores the autonomous movement of the mobile robot 100. The start switch 142 may activate at least one of the predetermined functions of the mobile robot 100 that have been stopped. For example, when the forced stop switch 141 stops the function of the drive unit 110 as the moving means, the start switch 142 activates the function of the drive unit 110 as the moving means. When the forced stop switch 141 stops the function of the communication unit 130 as the communication means, the start switch 142 may activate the function of the communication unit 130 as the communication means. When the forced stop switch 141 stops the sensor function of the sensor group 160, the start switch 142 may activate the sensor function of the sensor group 160. When the activation of the forced stop switch 141 is released and the autonomous movement is restored due to the activation of the start switch 142, the transmission of the heartbeat signal may be resumed. As a result, the server device 300 can detect that the mobile robot 100 has restored the autonomous movement.

The control unit 180 is an information processing device including an arithmetic device such as a central processing unit (CPU). The control unit 180 includes hardware provided in the control unit 180 and a program stored in the hardware. That is, processes executed by the control unit 180 are realized by either hardware or software.

The control unit 180 acquires various types of information from each configuration and issues a command to each configuration in accordance with the acquired information. For example, the control unit 180 detects the distance between the mobile robot 100 and the surrounding object from the image data acquired from the robot camera 161 and the information on the object around the mobile robot 100 acquired from the distance sensor 162. Then, the control unit 180 calculates a route to the destination from the detected distance, and commands the drive unit 110 to move along the route in accordance with the calculated route. When executing such a process, the control unit 180 refers to information related to a floor map stored in the storage unit 190.

The control unit 180 causes the drive unit 110 to move to the base point 600 fixed in the facility 900. Then, the sensor group 160 or the communication unit 130 is made to acquire the base point information.

Further, when restoring the autonomous movement of the mobile robot 100, the control unit 180 causes the communication unit 130 to acquire the position information from the facility camera 400 or the other mobile robot 100A. For example, the communication unit 130 acquires the image data from the facility camera 400 that has captured the image of the mobile robot 100. The communication unit 130 may acquire the image data from the other mobile robot 100A that has captured the image of the mobile robot 100. The image data includes the position information of the mobile robot 100. Further, the communication unit 130 may acquire the position information of the other mobile robot 100A from the other mobile robot 100A. The position information of the other mobile robot 100A includes the position information from the point of view of the mobile robot 100. The control unit 180 causes the arithmetic unit 185 to calculate the position information related to the mobile robot 100 from the position information acquired from the other mobile robot 100A.

Specifically, the arithmetic unit 185 can calculate the position information in the facility 900 from the position of the mobile robot 100 whose captured image is included in the acquired image data. Further, the arithmetic unit 185 can calculate the position information by adding the distance information from the other mobile robot 100A to the position information of the other mobile robot 100A.

The control unit 180 may acquire information indicating the direction of the mobile robot 100 together with the position information. Here, the forward direction of the mobile robot 100 is referred to as the direction of the mobile robot 100, and the information indicating the direction of the mobile robot 100 is referred to as direction information.

When the forced stop switch 141 is activated, the control unit 180 causes the communication unit 130 to stop the transmission of the heartbeat signal that is periodically transmitted to the server device 300. When the activation of the forced stop switch 141 is released and the autonomous movement is restored, the control unit 180 causes the communication unit 130 to resume the transmission of the heartbeat signal. As a result, the position information is acquired via the server device 300.

When the forced stop switch 141 is activated, the control unit 180 may cause the communication unit 130 to notify the administrator of the mobile robot 100 of the activation of the forced stop switch 141.

The storage unit 190 includes a non-volatile memory such as a flash memory and a solid state drive (SSD). The storage unit 190 stores the position information. The storage unit 190 may update the position information at any time, for example, every time the mobile robot 100 moves. The storage unit 190 stores the floor map of the facility used by the mobile robot 100 for the autonomous movement. The storage unit 190 is connected to the control unit 180, and outputs stored information to the control unit 180 in response to a request from the control unit 180.

As shown in FIG. 2, the mobile robot 100 has the +X-axis direction side on which the robot camera 161 is installed as the front. That is, during normal movement, the traveling direction is the +X-axis direction as shown by the arrow.

Various ideas can be adopted for how to define the front of the mobile robot 100. For example, the front can be defined based on how the sensor group 160 for recognizing the surrounding environment is disposed. Specifically, the +X-axis direction side of the housing unit 120 on which the sensor having high recognition ability is disposed or many sensors are disposed can be set as the front. By defining the front as described above, the mobile robot 100 can move while recognizing the surrounding environment more accurately. The mobile robot 100 according to the present embodiment also has the +X-axis direction side on which the robot camera 161 is disposed as the front, for example.

Alternatively, the front can be defined based on how the display unit 150 is disposed. When the display unit 150 displays the face of the character or the like, the surrounding people naturally recognize that the display unit 150 is the front of the mobile robot 100. Therefore, when the display surface side of the display unit 150 is set as the front, there is little discomfort to the surrounding people. The mobile robot 100 according to the present embodiment also has the display surface side of the display unit 150 as the front.

Further, the front may be defined based on a shape of the housing of the mobile robot 100. For example, when the projected shape of the housing unit 120 on the traveling surface is rectangular, it is better to have the short side as the front than the longitudinal side as the front, whereby people who pass by the mobile robot 100 are not obstructed during moving. That is, depending on the shape of the housing, there is a housing surface that is preferably set as the front when the mobile robot 100 moves normally. The mobile robot 100 according to the present embodiment has the short side of the rectangular shape as the front.

Operation of Mobile Robot

Next, the operation of the mobile robot 100 according to the present embodiment will be described. For example, the user turns on the power supply of the mobile robot 100. Then, the user inputs a desired task to the operation reception unit 140. When necessary, the ID sensor 170 identifies the ID of the user when the power supply is turned on or when the user operates the operation reception unit 140.

In order to transport the object as a desired task, the user operates the operation reception unit 140 to open the storage chamber door 121 and store the object in the storage chamber. Then, the user operates the operation reception unit 140 to close the storage chamber door 121. Next, the user inputs the destination of the object using the operation reception unit 140. The control unit 180 of the mobile robot 100 searches for a route to the destination using the floor map stored in the storage unit 190. The mobile robot 100 autonomously moves in the facility 900 along the searched route using the position information.

The mobile robot 100 may lose the acquired position information when moving along the route in the facility 900. For example, the mobile robot 100 loses the position information due to the activation of the forced stop switch 141 for stopping the autonomous movement of the mobile robot 100. The mobile robot 100 may be brought to an error state due to the activation of the forced stop switch 141 and may lose the position information. Further, when the forced stop switch 141 is activated, the mobile robot 100 may not be able to acquire a new mileage and a traveling direction, and may not be able to acquire accurate distance information. As a result, the mobile robot 100 loses the position information.

The forced stop switch 141 is activated by a hospital staff, a patient, or the like when, for example, transportation of a transported object that is more urgent than the task of the mobile robot 100 is prioritized, or when passage of a patient of the hospital is prioritized. When the forced stop switch 141 is activated, the position of the mobile robot 100 may be moved from the outside. Also due to the above, the mobile robot 100 loses the position information.

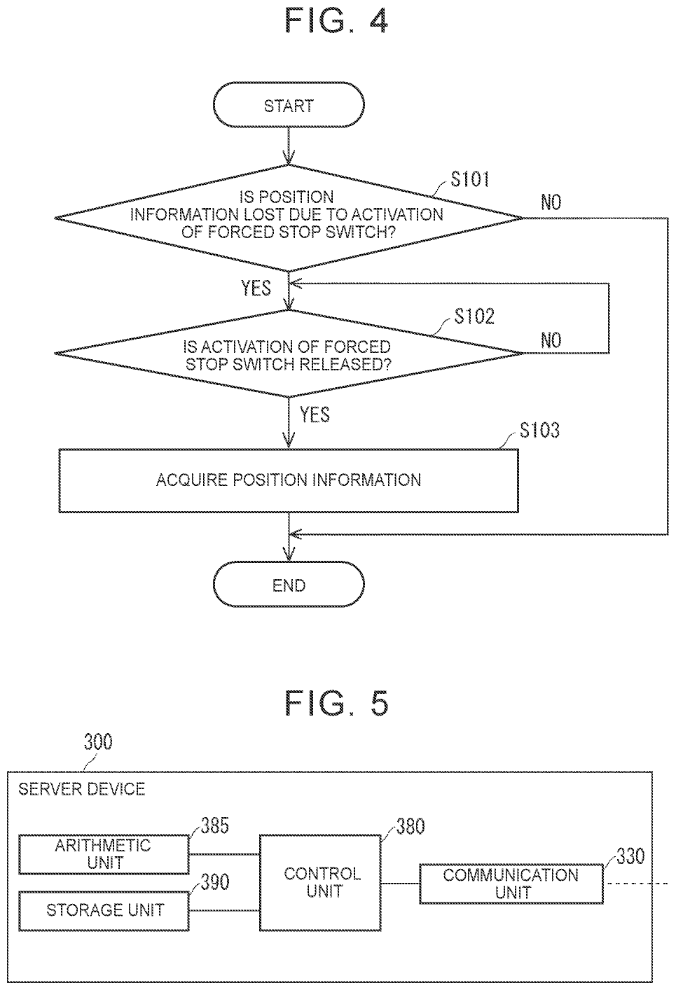

Next, the operation in which the mobile robot 100 that has lost the position information acquires the position information is described. FIG. 4 is a flowchart illustrating the operation of acquiring the position information when the mobile robot 100 according to the first embodiment loses the position information due to the activation of the forced stop switch for stopping the autonomous movement. As shown in step S101 in FIG. 4, the control unit 180 of the mobile robot 100 determines whether the mobile robot 100 has lost the position information due to the activation of the forced stop switch 141. In step S101, when the mobile robot 100 has not lost the position information due to the activation of the forced stop switch 141, the process ends.

In contrast, in step S101, when the mobile robot 100 has lost the position information due to the activation of the forced stop switch 141, the control unit 180 of the mobile robot 100 determines whether the activation of the forced stop switch 141 has been released, as shown in step S102. For example, it is determined whether the activation of the forced stop switch 141 has been released due to the activation of the start switch 142. In step S102, when the activation of the forced stop switch 141 has not been released, step S102 is repeated.

In contrast, in step S102, when the activation of the forced stop switch 141 has been released, the mobile robot 100 acquires the position information as shown in step S103. Specifically, when the activation of the forced stop switch 141 is released and the autonomous movement is restored, the control unit 180 of the mobile robot 100 acquires the position information from the facility camera 400 that has captured the image of the mobile robot 100 or the other mobile robot 100A that has detected the mobile robot 100.

For example, the mobile robot 100 acquires the position information as the image data from the facility camera 400 or the other mobile robot 100A. Further, the mobile robot 100 may acquire the position information of the other mobile robot 100A from the mobile robot 100A.

The arithmetic unit 185 calculates the position information related to the mobile robot 100 from the position information acquired from the facility camera 400 or the other mobile robot 100A. Specifically, the arithmetic unit 185 acquires the image data of the mobile robot 100 acquired from the facility camera 400 or the other mobile robot 100A to calculate the position information related to the mobile robot 100 and the obstacle around the mobile robot 100. Alternatively, the arithmetic unit 185 calculates the position information of the mobile robot 100 by adding the distance information to the position information acquired from the other mobile robot 100A. In this way, the mobile robot 100 calculates the position information including the position of the mobile robot 100 from the position information acquired from the facility camera 400 or the other mobile robot 100A.

The position information acquired from the facility camera 400 in the facility 900 and the position information acquired from the other mobile robot 100A are not directly acquired by the sensor group 160 of the mobile robot 100. Therefore, the above position information may have a lower accuracy compared to the position information that the mobile robot 100 has directly acquired by positioning at the base point 600.

Therefore, the mobile robot 100 that has acquired the position information from the facility camera 400 or the other mobile robot 100A may move to the base point 600 fixed in the facility 900 to position at the base point 600, thereby acquiring the base point information serving as a reference for the position information. Specifically, the control unit 180 causes the mobile robot 100 to position at the base point 600 fixed in the facility 900 to cause the mobile robot 100 to acquire the position information. Then, the control unit 180 causes the arithmetic unit 185 to calculate the position information by adding the distance information acquired from the robot camera 161 and the distance sensor 162 to the position information acquired from the base point 600 serving as an initial value. As a result, the accuracy of the position in the facility 900 can be improved.

The mobile robot 100 can grasp the position in the facility 900 solely from the distance information acquired from the robot camera 161 and the distance sensor 162, without using the position information acquired from the base point 600 as the initial value. However, such position information is not based on the position information acquired from the base point 600, thereby decreasing the accuracy of the position in the facility 900. Even when the mobile robot 100 uses the position information acquired from the base point 600 as the initial value, with longer mileage, positional errors accumulate, thereby decreasing the accuracy of the position. Thus, it is preferable that the mobile robot 100 periodically positions at the base point 600 to acquire the position information from the base point 600.

According to the present embodiment, when the mobile robot 100 has lost the position information due to the activation of the forced stop switch 141 for stopping the autonomous movement, the mobile robot 100 acquires the position information from the facility camera 400 or the other mobile robot 100A. Thus, the mobile robot 100 can be easily restored even when losing the position information. Further, the direction information of the mobile robot 100 is acquired together with the position information. Thereby, the mobile robot 100 can be easily restored.

For example, when restarting the mobile robot 100 that has been forcibly stopped by the forced stop switch 141 or the like for other urgent transportations in the facility 900, the mobile robot 100 needs to be made to acquire the position information. In this case, it is conceivable that the mobile robot 100 is caused to acquire the position information by carrying the mobile robot 100 that has been restarted to the base point 600 by the user. However, this method causes a great burden for the user.

In view of this, in the present embodiment, the mobile robot 100 acquires the position information from the facility camera 400 or the other mobile robot 100A after being restarted. Thus, the mobile robot 100 can be easily restored even when losing the position information. This can also eliminate the need to install targets such as RFID tags and landmarks in advance in the facility 900 for restoring the autonomous movement of the mobile robot 100 that has lost the position information.

The mobile robot 100 resumes the transmission of the heartbeat signal when restoring the autonomous movement, thereby acquiring the position information via the server device 300. Therefore, the server device 300 can easily detect the activation of the forced stop switch.

Furthermore, the mobile robot 100 can use the acquired position information to autonomously move to the base point 600, in order to acquire highly accurate position information. This can reduce the burden of the user and highly accurate position information can be acquired easily.

### Second Embodiment

Next, an autonomous mobile system according to a second embodiment will be described. The autonomous mobile system is a system that controls an autonomous mobile device that autonomously moves in the predetermined facility 900, using the server device 300 and the facility camera 400. The autonomous mobile system will be described separately in “Configuration of Autonomous Mobile System” and “Operation of Autonomous Mobile System”.

Configuration of Autonomous Mobile System

The autonomous mobile system includes the mobile robot 100, the server device 300, and the facility camera 400. The autonomous mobile system may include a plurality of the mobile robots 100.

Mobile Robot

The configuration of the mobile robot 100 according to the present embodiment is the same as that of the above-described first embodiment. The mobile robot 100 according to the present embodiment may cause the server device 300 to execute some of the functions of the mobile robot 100 according to the first embodiment. For example, the image data captured by the facility camera 400 may be acquired by the server device 300, and the server device 300 may be made to calculate the position information of the mobile robot 100. Further, the image data and the position information of the other mobile robot 100A may be acquired by the server device 300, and the server device 300 may be made to calculate the position information of the mobile robot 100. The mobile robot 100 may acquire the position information calculated by the server device 300 from the server device 300.

Server Device

The server device 300 is, for example, a computer having a communication function. The server device 300 may be installed at any place as long as the server device 300 can communicate with each configuration of the autonomous mobile system. The server device 300 may transmit and receive the traveling information to and from the mobile robot 100, and may acquire the image data from the facility camera 400.

FIG. 5 is a block diagram illustrating the server device according to the second embodiment. As shown in FIG. 5, the server device 300 includes a communication unit 330, a control unit 380, an arithmetic unit 385, and a storage unit 390.

The communication unit 330 communicates with the mobile robot 100 and the facility camera 400 individually. The communication unit 330 outputs a signal received from each configuration to the control unit 380. Further, the communication unit 330 appropriately transmits a signal output from the control unit 380 to each configuration. The communication unit 330 may include a router device for performing communication between a plurality of the mobile robots 100, the facility camera 400, and the like. The communication unit 330 may include different communication means for performing communication between a plurality of the mobile robots 100, the facility camera 400, and the like. The communication unit 330 may be communicably connected to each configuration via an intranet line or the Internet line.

The communication unit 330 may periodically receive the heartbeat signal from the mobile robot 100. When the transmission of the heartbeat signal is stopped and resumed, the communication unit 330 notifies the control unit 380 of the stop and resumption of the heartbeat signal.

The communication unit 330 may request the facility camera 400 and the other mobile robot 100A to provide the image data of the mobile robot 100, and receive the image data. Further, the communication unit 330 may request the other mobile robot 100A to provide the position information, and receive the position information. The communication unit 330 transmits the position information and the like calculated from the image data to the mobile robot 100. The communication unit 330 may transmit the direction information indicating the direction of the mobile robot 100 together with the position information of the mobile robot 100.

The control unit 380 is configured by an arithmetic device such as a CPU and executes various types of information processing. The control unit 380 is notified of the stop of the heartbeat signal of the mobile robot 100 from the communication unit 330. When the forced stop switch 141 is activated, the control unit 380 may control the communication unit 330 so that the communication unit 330 notifies the administrator of the autonomous mobile system of the activation of the forced stop switch 141.

The control unit 380 is notified of the resumption of the heartbeat signal of the mobile robot 100 from the communication unit 330. The control unit 380 causes the communication unit 330 to acquire the image data from the facility camera 400 and the other mobile robot 100A, and to acquire the position information from the other mobile robot 100A. Further, the control unit 380 causes the arithmetic unit 385 to calculate the position information of the mobile robot 100 from the image data, and calculate the position information of the mobile robot 100 from the position information acquired from the other mobile robot 100A. The control unit 380 controls the communication unit 330 so that the communication unit 330 transmits the calculated position information to the mobile robot 100.

The arithmetic unit 385 calculates the position information of the mobile robot 100 from the image data of the mobile robot 100. Alternatively, the arithmetic unit 385 calculates the position information of the mobile robot 100 from the position information acquired from the other mobile robot 100A.

As described above, in the case where the mobile robot 100 has lost the position information due to the activation of the forced stop switch 141 for stopping the autonomous movement, when the activation of the forced stop switch 141 is released and the autonomous movement is restored, the position information is acquired from the facility camera 400 that has captured the image of the mobile robot 100 or the other mobile robot 100A that has detected the mobile robot 100. Then, the position information of the mobile robot 100 is calculated from the acquired position information. In this way, the server device 300 acquires the position information of the mobile robot 100. Subsequently, the server device 300 transmits the acquired position information to the mobile robot 100.

The storage unit 390 includes a non-volatile memory such as a flash memory and an SSD. The storage unit 390 stores the floor map of the facility used by the mobile robot 100 for the autonomous movement. The storage unit 390 is connected to the control unit 380, and outputs stored information to the control unit 380 in response to a request from the control unit 380.

Operation of Autonomous Mobile System

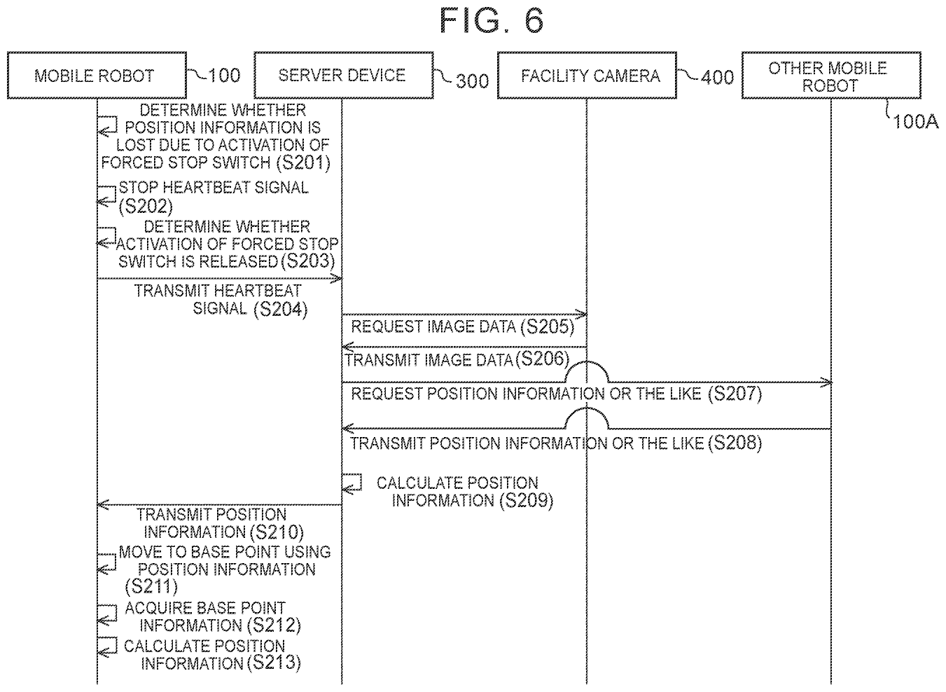

Next, the operation of the autonomous mobile system will be described. FIG. 6 is a sequence diagram illustrating the operation of the autonomous mobile system according to the second embodiment. As shown in step S201 in FIG. 6, the mobile robot 100 determines whether the position information has been lost due to the activation of the forced stop switch 141. In step S201, when the position information has not been lost due to the activation of the forced stop switch 141, the process ends.

In contrast, in step S201, when the position information has been lost due to the activation of the forced stop switch 141, the mobile robot 100 stops the transmission of the heartbeat signal that is periodically transmitted to the server device 300, as shown in step S202.

Next, as shown in step S203, the mobile robot 100 determines whether the activation of the forced stop switch 141 has been released. When the activation of the forced stop switch 141 has not been released, step S203 is repeated.

In contrast, in step S203, when the activation of the forced stop switch 141 has been released, the mobile robot 100 resumes the transmission of the heartbeat signal as shown in step S204. Thus, the server device 300 detects the loss of the position information of the mobile robot 100. For example, the heartbeat signal includes the ID information and the log data of the mobile robot 100 that has lost the position information. As a result, the server device 300 can detect which mobile robot 100 has lost the position information.

Next, as shown in step S205, the server device 300 requests the facility camera 400 to provide the image data of the mobile robot 100. In response to the request, as shown in step S206, the facility camera 400 transmits the image data of the mobile robot 100 to the server device 300.

Alternatively, as shown in step S207, the server device 300 requests the other mobile robot 100A to provide the image data or the position information of the mobile robot 100 (hereinafter referred to as “position information or the like”). In response to this, as shown in step S208, the other mobile robot 100A transmits the position information or the like to the server device 300.

Next, as shown in step S209, the server device 300 calculates the position information of the mobile robot 100 from the image data of the mobile robot 100 captured by the facility camera 400 and the mobile robot 100A. Alternatively, the server device 300 calculates the position information of the mobile robot 100 from the position information held by the other mobile robot 100A that has detected the mobile robot 100. In this way, the server device 300 acquires the position information of the mobile robot 100.

Subsequently, as shown in step S210, the server device 300 transmits the acquired position information of the mobile robot 100 to the mobile robot 100.

The mobile robot 100 may improve the accuracy of the position information. For example, as shown in step S211, the mobile robot 100 may move to the base point 600 using the position information. Then, as shown in step S212, by positioning at the base point 600, the mobile robot 100 may acquire the base point information that serves as a reference for the position information. Thus, as shown in step S213, the mobile robot 100 can calculate the position information based on the base point information. As a result, the mobile robot 100 moves in the facility 900 using the calculated position information.

According to the present embodiment, when the activation of the forced stop switch 141 is released and the autonomous movement is restored, the server device 300 calculates the position information of the mobile robot 100 from the image data of the mobile robot 100 captured by the facility camera 400 or the other mobile robot 100A. Alternatively, the server device 300 calculates the position information of the mobile robot 100 from the position information held by the other mobile robot 100A that has detected the mobile robot 100. Since the server device 300 acquires the position information on behalf of the mobile robot 100, the load on the mobile robot 100 can be reduced, and the processing speed of the mobile robot 100 can also be improved.

The mobile robot 100 notifies the server device 300 of the state of the mobile robot 100 such as the loss of the position information of the mobile robot 100 by stopping or resuming the transmission of the heartbeat signal. Thus, the server device 300 can immediately grasp the state of the mobile robot 100, and perform appropriate processes for the mobile robot 100 such as the acquisition of the position information. Other configurations, operations, and effects are included in the description of the first embodiment.

The present disclosure is not limited to the above embodiments, and can be appropriately modified without departing from the spirit. For example, a combination of the configurations of the first and second embodiments is also included in the scope of the technical idea of the present embodiment. In addition, the autonomous mobile method and the autonomous mobile program described below are also included in the scope of the technical idea of the present embodiment.

### APPENDIX 1

An autonomous mobile method for an autonomous mobile device that autonomously moves in a facility using position information, the autonomous mobile method comprising causing the autonomous mobile device to acquire the position information from a facility camera in the facility that has captured an image of the autonomous mobile device or from another autonomous mobile device that has detected the autonomous mobile device, in a case where the autonomous mobile device has lost the position information due to an activation of a forced stop switch for stopping autonomous movement of the autonomous mobile device, and when the activation of the forced stop switch is released and the autonomous movement is restored.

### APPENDIX 2

The autonomous mobile method according to Appendix 1, comprising:

causing the autonomous mobile device to stop transmission of a heartbeat signal that is periodically transmitted to a server device communicably connected to the autonomous mobile system, when the forced stop switch is activated; and
causing the autonomous mobile device to resume the transmission of the heartbeat signal to acquire the position information via the server device, when the activation of the forced stop switch is released and the autonomous movement is restored.

### APPENDIX 3

The autonomous mobile method according to Appendix 1 or 2, comprising causing the autonomous mobile device to acquire direction information indicating a direction of the autonomous mobile system together with the position information.

### APPENDIX 4

The autonomous mobile method according to any one of Appendices 1 to 3, comprising causing the autonomous mobile device to notify an administrator of the autonomous mobile system of the activation of the forced stop switch, when the forced stop switch is activated.

### APPENDIX 5

The autonomous mobile method according to any one of Appendices 1 to 4, comprising

causing the autonomous mobile device that has acquired the position information to move to a base point fixed in the facility, and
acquire base point information that serves as a reference for the position information by causing the autonomous mobile device to position at the base point.

### APPENDIX 6

An autonomous mobile program for an autonomous mobile device that autonomously moves in a facility using position information, the autonomous mobile program causing a computer to execute acquisition of the position information by the autonomous mobile device from a facility camera in the facility that has captured an image of the autonomous mobile device or from another autonomous mobile device that has detected the autonomous mobile device, in a case where the autonomous mobile device has lost the position information due to an activation of a forced stop switch for stopping autonomous movement of the autonomous mobile device, and when the activation of the forced stop switch is released and the autonomous movement is restored.

### APPENDIX 7

The autonomous mobile program according to Appendix 6, causing the computer to execute:

stop, by the autonomous mobile device, of transmission of a heartbeat signal that is periodically transmitted to a server device communicably connected to the autonomous mobile system, when the forced stop switch is activated; and
resumption, by the autonomous mobile device, of the transmission of the heartbeat signal to acquire the position information via the server device, when the activation of the forced stop switch is released and the autonomous movement is restored.

### APPENDIX 8

The autonomous mobile program according to Appendix 6 or 7, causing the computer to execute acquisition, by the autonomous mobile device, of direction information indicating a direction of the autonomous mobile system together with the position information.

### APPENDIX 9

The autonomous mobile program according to any one of Appendices 6 to 8, causing the computer to execute notification, by the autonomous mobile device, of an administrator of the autonomous mobile system of the activation of the forced stop switch, when the forced stop switch is activated.

### APPENDIX 10

The autonomous mobile program according to any one of Appendices 6 to 9, causing the computer to execute, by the autonomous mobile device that has acquired the position information,

movement to a base point fixed in the facility, and
acquisition of base point information that serves as a reference for the position information by causing the autonomous mobile device to position at the base point.

What is claimed is:

1. An autonomous mobile system that autonomously moves in a facility using position information, wherein in a case where the position information is lost due to an activation of a forced stop switch for stopping autonomous movement of the autonomous mobile system, when the activation of the forced stop switch is released and the autonomous movement is restored, the autonomous mobile system acquires the position information from a facility camera in the facility that has captured an image of the autonomous mobile system or from another autonomous mobile system that has detected the autonomous mobile system.

2. The autonomous mobile system according to claim 1, wherein:
when the forced stop switch is activated, transmission of a heartbeat signal that is periodically transmitted to a server device communicably connected to the autonomous mobile system is stopped; and
when the activation of the forced stop switch is released and the autonomous movement is restored, the autonomous mobile system resumes the transmission of the heartbeat signal to acquire the position information via the server device.

3. The autonomous mobile system according to claim 1, wherein the autonomous mobile system acquires direction information indicating a direction of the autonomous mobile system together with the position information.

4. The autonomous mobile system according to claim 1, wherein when the forced stop switch is activated, the autonomous mobile system notifies an administrator of the autonomous mobile system of the activation of the forced stop switch.

5. The autonomous mobile system according to claim 1, wherein the autonomous mobile system that has acquired the position information
moves to a base point fixed in the facility, and
acquires base point information that serves as a reference for the position information by positioning at the base point.

6. An autonomous mobile system comprising:
an autonomous mobile device that autonomously moves in a facility using position information;
a facility camera that is fixed in the facility and captures an image of a periphery of the facility camera to generate image data; and
a server device that transmits and receives traveling information to and from the autonomous mobile device, and acquires the image data from the facility camera, wherein:
in a case where the autonomous mobile device has lost the position information due to an activation of a forced stop switch for stopping autonomous movement of the autonomous mobile device, when the activation of the forced stop switch is released and the autonomous movement is restored, the server device acquires the position information of the autonomous mobile device from the facility camera that has captured an image of the autonomous mobile device or from another autonomous mobile device that has detected the autonomous mobile device, and transmits the acquired position information to the autonomous mobile device; and
the autonomous mobile device acquires the position information from the server device.

7. The autonomous mobile system according to claim 6, wherein the autonomous mobile device
stops transmission of a heartbeat signal that is periodically transmitted to the server device, when the forced stop switch is activated, and
resumes the transmission of the heartbeat signal to acquire the position information via the server device, when the activation of the forced stop switch is released and the autonomous movement is restored.

8. The autonomous mobile system according to claim 6, wherein the autonomous mobile device acquires direction information indicating a direction of the autonomous mobile device together with the position information.

9. The autonomous mobile system according to claim 6, wherein the autonomous mobile device or the server device notifies an administrator of the autonomous mobile system of the activation of the forced stop switch, when the forced stop switch is activated.

10. The autonomous mobile system according to claim 6, wherein the autonomous mobile device that has acquired the position information
moves to a base point fixed in the facility, and
acquires base point information that serves as a reference for the position information by positioning at the base point.

11. An autonomous mobile method for an autonomous mobile device that autonomously moves in a facility using position information, the autonomous mobile method comprising causing the autonomous mobile device to acquire the position information from a facility camera in the facility that has captured an image of the autonomous mobile device or from another autonomous mobile device that has detected the autonomous mobile device, in a case where the autonomous mobile device has lost the position information due to an activation of a forced stop switch for stopping autonomous movement of the autonomous mobile device, and when the activation of the forced stop switch is released and the autonomous movement is restored.

12. An autonomous mobile program for an autonomous mobile device that autonomously moves in a facility using position information, the autonomous mobile program causing a computer to execute acquisition of the position information by the autonomous mobile device from a facility camera in the facility that has captured an image of the autonomous mobile device or from another autonomous mobile device that has detected the autonomous mobile device, in a case where the autonomous mobile device has lost the position information due to an activation of a forced stop switch for stopping autonomous movement of the autonomous mobile device, and when the activation of the forced stop switch is released and the autonomous movement is restored.
